(19) United States
(12) Patent Application Publication
(10) Pub. No.: US 2016/0014401 A1
(43) Pub. Date: Jan. 14, 2016

(54) DISPLAY APPARATUS AND METHOD OF DRIVING THE SAME

(71) Applicant: SAMSUNG DISPLAY CO., LTD., Yongin-City (KR)

(72) Inventors: Seokyun SON, Yongin-si (KR); Jai-Hyun KOH, Hwaseong-si (KR); Se Ah KWON, Seoul (KR); Jinpil KIM, Suwon-si (KR); Heendol KIM, Yongin-si (KR); Kuk-Hwan AHN, Hwaseong-si (KR); IK SOO LEE, Seoul (KR)

(21) Appl. No.: 14/603,535

(22) Filed: Jan. 23, 2015

(30) Foreign Application Priority Data
Jul. 10, 2014 (KR) 10-2014-0086895

(51) Int. Cl. H04N 13/04; G09G 3/00; G09G 3/20

(52) U.S. Cl. CPC H04N 13/0454; G09G 3/2003; G09G 3/001; H04N 13/0422; G09G 2320/10; G09G 2320/0673; G09G 2300/0452; G09G 2320/0666

(57) ABSTRACT

A display apparatus includes first pixels, second pixels, a gate driver, and a data driver. The first pixels receive data voltages in response to gate signals. The second pixels are alternately arranged with the first pixels in row and column directions and receive the data voltages in response to the gate signal. The gate and data drivers provide the gate and data signals, respectively, to the first and second pixels. Dual-gate signals each including two sub-gate signals having a same phase as each other are sequentially applied to the first and second pixels in the unit of two rows of odd-numbered rows and in the unit of two rows of even-numbered rows as the gate signals in a three-dimensional mode.

### CROSS-REFERENCE TO RELATED APPLICATION

This U.S. non-provisional patent application claims priority under 35 U.S.C. §119 to Korean Patent Application No. 10-2014-0086895, filed on Jul. 10, 2014, in the Korean Intellectual Property Office, the disclosure of which is incorporated by reference herein in its entirety.

### TECHNICAL FIELD

The present inventive concept relates to a display apparatus and a method of driving the display apparatus.

### DISCUSSION OF THE RELATED ART

For pixels arranged in a display apparatus, a pentile technology including four sub-pixels (e.g., RGBW) has been developed to increase an aperture ratio and a transmittance of the display apparatus compared to an RGB stripe technology including six sub-pixels (e.g., RGBRGB). Here, it is understood RGBW stands for red (R), green (G), blue (B), and white (W).

In the display apparatus employing the pentile technology, a resolution of the display apparatus may becomes lower as the number of the sub-pixels is reduced. To compensate for this reduction in resolution, the display apparatus employing the pentile technology may include a rendering module that renders RGB image data to RGBW sub-pixel data.

### SUMMARY

According to an exemplary embodiment of the present inventive concept, a display apparatus is provided. The display apparatus includes first pixels, second pixels, a gate driver, and a data driver. The first pixels are configured to receive data voltages in response to gate signals. The second pixels are alternately arranged with the first pixels in a row direction and a column direction. The second pixels are configured to receive the data voltages in response to the gate signals. The gate driver is configured to provide the gate signals to the first and second pixels. The data driver is configured to provide the data voltages to the first and second pixels. Each of the first pixels includes sub-pixels different from sub-pixels of the second pixels. The gate signals are sequentially applied to the first and second pixels in a unit of row when the first and second pixels in a two-dimensional (2D) mode. Dual-gate signals each including two sub-gate signals having a same phase as each other are sequentially applied to the first and second pixels in a unit of two rows of odd-numbered rows and in a unit of two rows of even-numbered rows as the gate signals in a three-dimensional (3D) mode.

The gate signals may be applied to the first and second pixels each frame during the 2D mode.

The frame may include a first sub-frame and a second sub-frame. A left-eye image may be displayed in the first sub-frame, and a right-eye image may be displayed in the second sub-frame. The double-gate signals may be applied to the first and second pixels each sub-frame during the 3D mode.

Each of the first pixels may include a red sub-pixel and a green sub-pixel, and each of the second pixels may include a blue sub-pixel and a white sub-pixel.

The display apparatus may further include a timing controller. The timing controller may be configured to render input image data to correspond to the sub-pixels, to convert a data format of the rendered image data, and to apply the image data having the converted data format to the data driver. The data driver may output the data voltages corresponding to the image data having the converted data format.

The input image data may include red, green, and blue image data. The timing controller may include a gamma compensating part, a mapping part, a sub-pixel rendering part, and a reverse-gamma compensating part. The gamma compensating part may be configured to linearize the red, green, and blue image data. The mapping part may be configured to map the linearized red, green, and blue image data to red, green, blue, and white image data. The sub-pixel rendering part may be configured to render the mapped red, green, blue, and white image data, and to output the rendered red, green, blue, and white image data corresponding to the sub-pixels. The reverse-gamma compensating part may be configured to perform reverse-gamma compensation on the rendered red, green, blue, and white image data.

The sub-pixel rendering part may include at least one of a first rendering filter, a second rendering filter, or a third rendering filter. The first rendering filter may be used to render the mapped red, green, blue, and white image data to correspond to the sub-pixels during the 2D mode. The second rendering filter may be used to render the mapped red, green, blue, and white image data to correspond to sub-pixels arranged in the odd-numbered rows, among the sub-pixels, during the 3D mode. The third rendering filter may be used to render the mapped red, green, blue, and white image data to correspond to sub-pixels arranged in the even-numbered rows, among the sub-pixels, during the 3D mode.

The first rendering filter includes first sub-filters arranged in first to third rows and first to third columns. The first sub-filters have corresponding scale coefficients, respectively. The sub-pixel rendering part may be configured to set first and second pixels, among the first and second pixels, arranged in the first to third rows and the first to third columns to correspond to the first sub-filters, to set a first or second pixel arranged in the second row and the second column among the set first and second pixels as a reference pixel, to multiply first image data corresponding to a color of a sub-pixel of the reference pixel, among the mapped red, green, blue, and white image data corresponding to the set first and second pixels, by corresponding scale coefficients of the first sub-filters corresponding to the first image data, respectively, and to calculate a sum of the multiplied values as a rendered image data corresponding to the sub-pixel of the reference pixel.

A sum of the scale coefficients of the first sub-filters may be about 1, a scale coefficient of the first sub-filter arranged in the second row and the second column may be about 0.5, a scale coefficient of each of the first sub-filters respectively arranged in the first row and the second column, the second row and the first column, the second row and the third column, and the third row and the second column may be about 0.125, and a scale coefficient of each of the first sub-filters respectively arranged in the first row and the first column, the first row and the third column, the third row and the first column, and the third row and the third column may be 0.

The second rendering filter may include second sub-filters arranged in first to third rows and first to third columns. The second sub-filters may have corresponding scale coefficients, respectively. The sub-pixel rendering part may be configured to set first and second pixels, among the first and second pixels, arranged in the first to third rows and the first to third columns to correspond to the second sub-filters, to set one first or second pixel arranged in the first row and the second column among the set first and second pixels as a first reference pixel, to set another first or second pixel arranged in the third row and the second column among the set first and second pixels as a second reference pixel, to multiply first image data corresponding to a first color of sub-pixels of the first and second reference pixels, among the mapped red, green, blue, and white image data corresponding to the set first and second pixels, by corresponding scale coefficients of the second sub-filters corresponding to the first image data, respectively, and to calculate a sum of the multiplied values as rendered image data corresponding to the sub-pixels of the first and second reference pixels. The first and third rows among the first to third rows may correspond to the two rows of the odd-numbered rows to which one of the double-gate signals is applied.

The third rendering filter may include third sub-filters arranged in first to third rows and first to third columns. The third sub-filters may store corresponding scale coefficients, respectively. The sub-pixel rendering part may be configured to set first and second pixels, among the first and second pixels, arranged in the first to third rows and the first to third columns to correspond to the third sub-filters, to set one first or second pixel arranged in the first row and the second column among the set first and second pixels as a first reference pixel, to set another first or second pixel arranged in the third row and the second column among the set first and second pixels as a second reference pixel, to multiply first image data corresponding to a first color of sub-pixels of the first and second reference pixels, among the mapped red, green, blue, and white image data corresponding to the set first and second pixels, by corresponding scale coefficients of the third sub-filters corresponding to the first image data, respectively, and to calculate a sum of the multiplied values as rendered image data corresponding to the sub-pixels of the first and second reference pixels. The first and third rows among the first to third rows may correspond to the two rows of the even-numbered rows to which one of the double-gate signals is applied.

According to an exemplary embodiment of the present inventive concept, a method of driving a display apparatus is provided. The display apparatus includes first pixels and second pixels. The first pixels are configured to receive data voltages in response to gate signals. The second pixels are alternately arranged with the first pixels in a row direction and a column direction. The second pixels are configured to receive the data voltages in response to the gate signals. Each of the second pixels includes sub-pixels different from sub-pixels of each of the first pixels. The method includes rendering input image data to image data corresponding to the sub-pixels, applying the gate signals to the first and second pixels, and applying the data voltages corresponding to the rendered image data to the first and second pixels. The gate signals are sequentially applied to the first and second pixels in a unit of row in a two-dimensional (2D) mode. Dual gate signals each including two sub-gate signals having a same phase as each other are sequentially applied to the first and second pixels in a unit of two rows of odd-numbered rows and in a unit of two rows of even-numbered rows as the gate signals in a three-dimensional (3D) mode.

According to an exemplary embodiment of the present inventive concept, a display apparatus is provided. The display apparatus includes first pixels, second pixels, a gate driver, a data driver, and a timing controller. The first pixels are configured to receive data voltages in response to gate signals. The second pixels are alternately arranged with the first pixels in a row direction and a column direction. The second pixels are configured to receive the data voltages in response to the gate signals. The gate driver is configured to provide the gate signals to the first and second pixels. The data driver is configured to provide the data voltages to the first and second pixels. The timing controller is configured to render input image data to image data corresponding to the sub-pixels. The timing controller includes a gamma compensating part, a mapping part, and a sub-pixel rendering part. The gamma compensating part is configured to linearize input red, green, and blue image data. The mapping part is configured to map the linearized red, green, and blue image data to red, green, blue, and white image data. The sub-pixel rendering part is configured to render the mapped red, green, blue, and white image data, and to output the rendered red, green, blue, and white image data corresponding to the sub-pixels. The sub-pixel rendering part includes a first rendering filter and a second rendering filter having a different scale coefficient from that of the first rendering filter.

The first rendering filter may be used to render the mapped red, green, blue, and white image data to correspond to sub-pixels arranged in the odd-numbered rows, among the sub-pixels, during the 3D mode. The second rendering filter may be used to render the mapped red, green, blue, and white image data to correspond to sub-pixels arranged in the even-numbered rows, among the sub-pixels, during the 3D mode.

### BRIEF DESCRIPTION OF THE DRAWINGS

The above and other aspects of the present inventive concept will become more apparent by describing in detail exemplary embodiments thereof with reference to the accompanying drawings in which:

FIG. 1 is a block diagram of a display apparatus according to an exemplary embodiment of the present inventive concept;

FIG. 2 is a view showing a configuration of pixels shown in FIG. 1 according to an exemplary embodiment of the present inventive concept;

FIG. 3 is a timing diagram of gate signals output from a gate driver when a mode signal is a two-dimensional mode signal according to an exemplary embodiment of the present inventive concept;

FIG. 4 is a timing diagram of gate signals output from a gate driver when a mode signal is a three-dimensional mode signal according to an exemplary embodiment of the present inventive concept;

FIG. 5 is a block diagram of a data processing device shown in FIG. 1 according to an exemplary embodiment of the present inventive concept;

FIGS. 6A, 6B, and 6C are views showing a rendering operation in a two-dimensional mode according to an exemplary embodiment of the present inventive concept;

FIGS. 7A and 7B are views showing a rendering operation of image data corresponding to pixels arranged in odd-numbered rows in a three-dimensional mode according to an exemplary embodiment of the present inventive concept;

FIGS. 8A and 8B are views showing a rendering operation of image data corresponding to pixels arranged in even-numbered rows in a three-dimensional mode according to an exemplary embodiment of the present inventive concept; and

FIG. 9 is a view showing a method of setting scale coefficients of second sub-filters of a second rendering filter according to an exemplary embodiment of the present inventive concept.

### DETAILED DESCRIPTION OF THE EMBODIMENTS

It will be understood that when an element or layer is referred to as being “on”, “connected to” or “coupled to” another element or layer, it can be directly on, connected or coupled to the other element or layer or intervening elements or layers may be present. Like numbers may refer to like elements throughout the specification and drawings.

As used herein, the singular forms, “a”, “an” and “the” are intended to include the plural forms as well, unless the context clearly indicates otherwise.

Hereinafter, exemplary embodiments of the present inventive concept will be described in more detail with reference to the accompanying drawings.

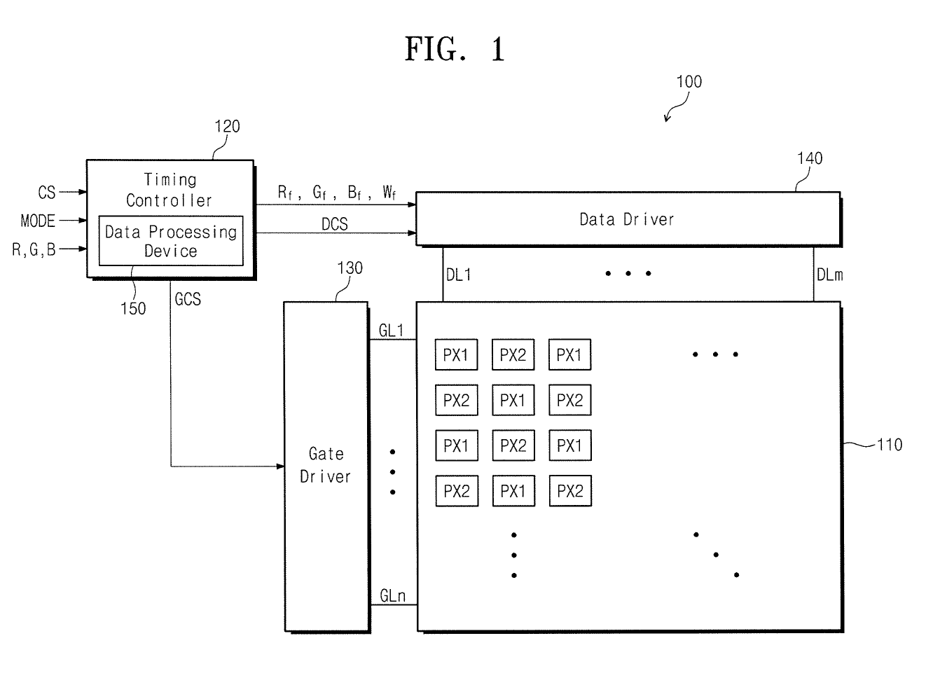

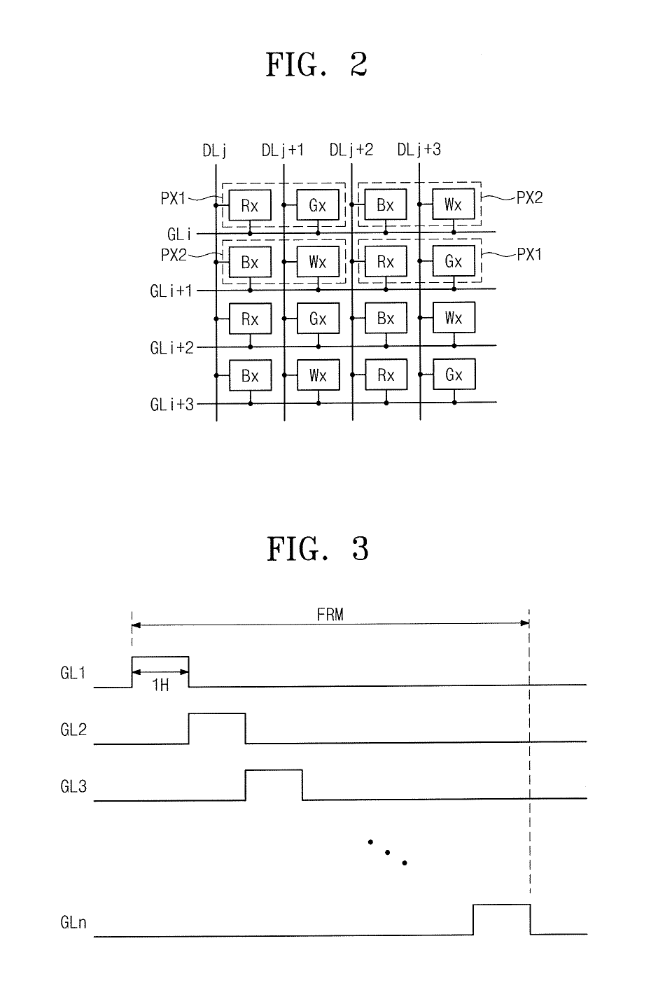

FIG. 1 is a block diagram of a display apparatus 100 according to an exemplary embodiment of the present inventive concept, and FIG. 2 is a view showing a configuration of pixels shown in FIG. 1 according to an exemplary embodiment of the present inventive concept.

Referring to FIGS. 1 and 2, the display apparatus 100 includes a display panel 110, a timing controller 120, a gate driver 130, and a data driver 140.

The display panel 110 includes a plurality of pixels PX1 and PX2 arranged in a matrix form. The pixels PX1 and PX2 include a plurality of first pixels PX1 and a plurality of second pixels PX2. The first pixels PX1 are alternately arranged with the second pixels PX2 in a row direction and a column direction.

Each of the first pixels PX1 and each of the second pixels PX2 include two sub-pixels. In addition, each of the first pixels PX1 includes different sub-pixels from those of each of the second pixels PX2. For example, each of the first pixels PX1 includes a red sub-pixel Rx and a green sub-pixel Gx, and each of the second pixels PX2 includes a blue sub-pixel Bx and a white sub-pixel Wx.

The red sub-pixel Rx displays a red color and the green sub-pixel Gx displays a green color. The blue sub-pixel Bx displays a blue color and the white sub-pixel Wx displays a white color.

The arrangement of the first and second pixels PX1 and PX2 shown in FIG. 2 corresponds to a pentile structure. In this case, the first and second pixels PX1 and PX2 arranged in odd-numbered rows are arranged in the same order as each other along the row direction, and the first and second pixels PX1 and PX2 arranged in even-numbered rows are arranged in the same order along the row direction.

Gate lines GL1 to GLn extend in the row direction and are connected to the gate driver 130. The gate lines GL1 to GLn receive gate signals from the gate driver 130.

Data lines DL1 to DLm extend in a column direction and are connected to the data driver 140. The data lines DL1 to DLm receive data voltages in an analog form from the data driver 140.

As shown in FIG. 2, the gate lines GLi to GLi+3 are arranged to cross the data lines DLj to DLj+3. The gate lines GLi to GLi+3 are electrically insulated from the data lines DLj to DLj+3. The red, green, blue, and white sub-pixels Rx, Gx, Bx, and Wx are connected to corresponding gate lines GLi to GLi+3 and corresponding data lines DLj to DLj+3, respectively.

For the convenience of explanation, FIG. 2 shows four gate lines GLi to GLi+3 among the gate lines GL1 to GLn and four data lines DLj to DLj+3 among the data lines DL1 to DLm. The gate lines GL1 to GLn are disposed on the display panel 110 and electrically insulated from the data lines DL1 to DLm when crossing the data lines DL1 to DLm. In addition, each of the sub-pixels Rx, Gx, Bx, and Wx is connected to a corresponding gate line of the gate lines GL1 to GLn and a corresponding data line of the data lines DL1 to DLm.

The sub-pixels connected to the odd-numbered gate lines GLi and GLi+2 and the data lines DLj to DLj+3 may be arranged in order of the red, green, blue, and white sub-pixels Rx, Gx, Bx, and Wx in the row direction. For example, the sub-pixels arranged in the odd-numbered rows may be arranged in the same order of the red, green, blue, and white sub-pixels Rx, Gx, Bx, and Wx in the row direction.

The sub-pixels connected to the even-numbered gate lines GLi+1 and GLi+3 and the data lines DLj to DLj+3 may be arranged in order of the blue, white, red, and green sub-pixels Bx, Wx, Rx, and Gx in the row direction. For example, the sub-pixels arranged in the even-numbered rows may be arranged in the same order of the blue, white, red, and green sub-pixels Bx, Wx, Rx, and Gx in the row direction.

For the convenience of explanation, FIG. 2 shows the first and second pixels PX1 and PX2 connected to the gate lines GLi to GLi+3 and the data lines DLj to DLj+3. The first and second pixels PX1 and PX2 connected to the gate lines GL1 to GLn and the data lines DL1 to DLm may be arranged in the same order as that of the sub-pixels shown in FIG. 2.

The timing controller 120 receives image data R, G, and B, a mode signal MODE, and a control signal CS from an external source (not shown), e.g., a system board.

The image data R, G, and B include two-dimensional (2D) image data and three-dimensional (3D) image data. In addition, the image data R, G, and B include a red image data R, a green image data G, and a blue image data B.

The timing controller 120 renders the red, green, and blue image data R, G, and B to red, green, blue, and white image data to correspond to the red, green, blue, and white sub-pixels Rx, Gx, Bx, and Wx of the display panel 110, respectively.

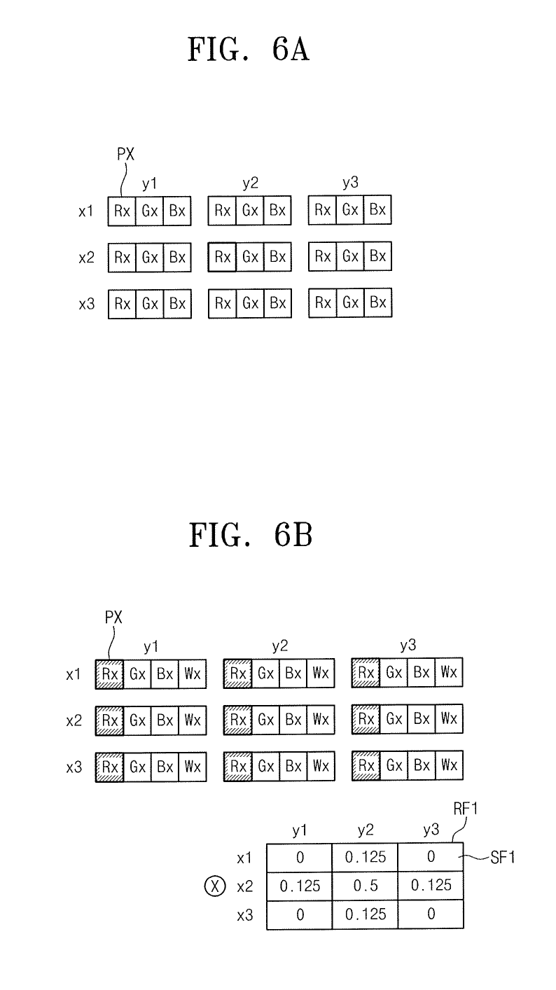

For example, the timing controller 120 includes a data processing device 150. The data processing device 150 renders the red, green, and blue image data R, G, and B to the red, green, blue, and white image data to correspond to the red, green, blue, and white sub-pixels Rx, Gx, Bx, and Wx, respectively. The rendering operation of the data processing device 150 will be described in detail with reference to FIGS. 5 to 8.

The timing controller 120 converts a data format of the rendered red, green, blue, and white image data to be appropriate to an interface between the data driver 140 and the timing controller 120. The red, green, blue, and white image data Rf, Gf, Bf, and Wf having the converted data format are applied to the data driver 140.

In an exemplary embodiment of the present inventive concept, the data processing device 150 is disposed in the timing controller 120, but the present inventive concept is not limited thereto. For example, the data processing device 150 may be disposed outside of the data processing device 150.

The mode signal MODE includes a 2D mode signal and a 3D mode signal. When the mode signal MODE is the 2D mode signal, the timing controller 120 receives the 2D image data R, G, and B from the external source and applies the 2D image data Rf, Gf, Bf, and Wf having the converted data format to the data driver 140.

When the mode signal MODE is the 3D mode signal, the timing controller 120 receives the 3D image data R, G, and B from the external source and applies the 3D image data Rf, Gf, Bf, and Wf having the converted data format to the data driver 140.

The 3D image data Rf, Gf, Bf, and Wf includes a left-eye image data and a right-eye image data. The timing controller 120 applies the left-eye image data and the right-eye image data to the data driver 140 in a time division scheme. For example, the left-eye image data and the right-eye image data are applied to the data driver 140, and thus the left-eye image data and the right-eye image data are sequentially displayed in the display panel 110 during one frame.

The timing controller 120 generates a gate control signal GCS and a data control signal DCS in response to the control signal CS. Although not shown in FIG. 1, the control signal CS includes a horizontal synchronization signal, a vertical synchronization signal, a main clock signal, and a data enable signal.

The gate control signal GCS is used to control an operation timing of the gate driver 130. The data control signal DCS is used to control an operation timing of the data driver 140.

Although not shown in FIG. 1, the data control signal DCS includes a latch signal, a horizontal start signal, a polarity control signal, and a clock signal. The gate control signal GCS includes a vertical start signal, a gate clock signal, and an output enable signal.

The timing controller 120 applies the gate control signal GCS to the gate driver 130 and applies the data control signal DCS to the data driver 140.

The timing controller 120 controls the gate driver 130 and the data driver 140 in response to the mode signal MODE, and thus the gate driver 130 and the data driver 140 are operated in the 2D or 3D mode.

For example, when the mode signal MODE is the 2D mode signal, the gate driver 130 outputs the gate signals in response to the gate control signal GCS. The gate signals are sequentially applied to the pixels PX through the gate lines GL1 to GLn in the unit of row, and thus the pixels PX may operate in the unit of row.

When the mode signal MODE is the 2D mode signal, the data driver 140 converts the 2D image data Rf, Gf, Bf, and Wf to the analog data voltages in response to the data control signal DCS. The data voltages are applied to the first and second pixels PX1 and PX2.

The first and second pixels PX1 and PX2 receive the data voltages corresponding to the 2D image data Rf, Gf, Bf, and Wf through the data lines DL1 to DLm in response to the gate signals. Therefore, the first and second pixels PX1 and PX2 display the 2D image using the data voltages corresponding to the 2D image data Rf, Gf, Bf, and Wf.

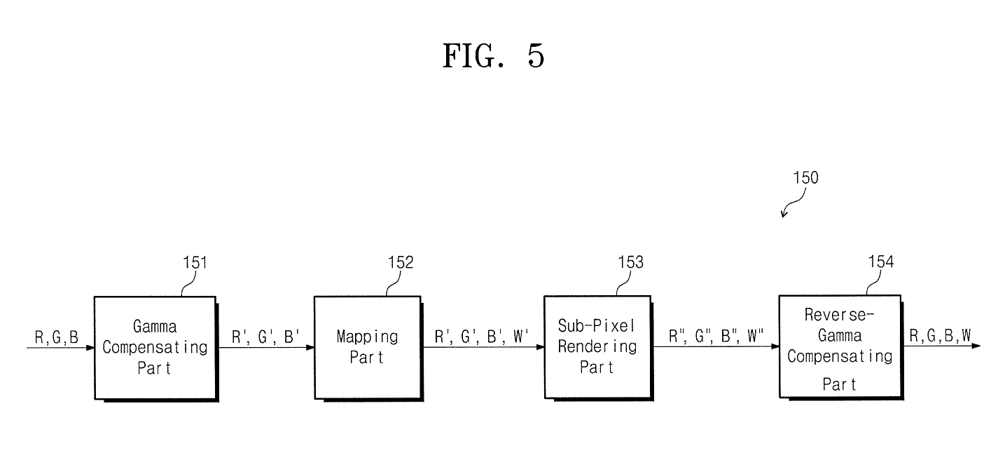

When the mode signal MODE is the 3D mode signal, the gate driver 130 outputs the gate signals in response to the gate control signal GCS. The gate signals are applied to the first and second pixels PX through the gate lines GL1 to GLn in a double-gate scheme. For example, dual-gate signals, which each include two sub-gate signals having the same phase as each other, are sequentially applied to the first and second pixels PX1 and PX in the unit of two rows of the odd-numbered rows and the even-number rows. The timing of the gate signals applied to the first and second pixels PX during the 3D mode will be described in detail with reference to FIG. 4.

When the mode signal MODE is the 3D mode signal, the data driver 140 converts the 3D image data Rf, Gf, Bf, and Wf to the analog data voltages in response to the data control signal DCS. The data voltages are applied to the first and second pixels PX1 and PX2.

The first and second pixels PX1 and PX2 receive the data voltages corresponding to the 3D image data Rf, Gf, Bf, and Wf through the data lines DL1 to DLm in response to the gate signals. The pixels PX display the left-eye image data and the right-eye image data using the data voltages corresponding to the 3D image data Rf, Gf, Bf, and Wf. Thus, the 3D image is provided to a viewer.

Although not shown in figures, the display apparatus 100 includes a left-circularly polarized filter that transmits a left circularly-polarized light and a right-circularly polarized filter that transmits a right circularly-polarized light after dividing the 3D image into each of the left and right polarized light components. The left-eye image and the right-eye image are provided to the viewer, respectively through the left-circularly polarized filter and the right-circularly polarized filter.

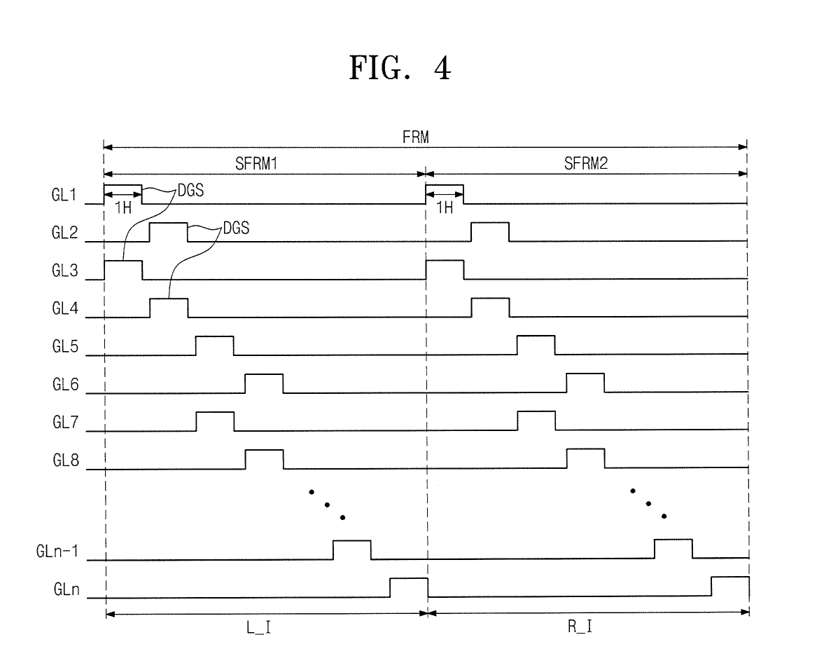

FIG. 3 is a timing diagram of gate signals output from a gate driver when a mode signal is a 2D mode signal according to an exemplary embodiment of the present inventive concept.

Referring to FIG. 3, when the mode signal is the 2D mode signal, the gate signals are sequentially output through the gate lines GL1 to GLn and are applied to the first and second pixels PX1 and PX2 during one frame FRM. For example, the gate signals are applied to the first and second pixels PX1 and PX2 each frame FRM. In addition, each of the gate signals has a predetermined activation period 1H, e.g., a high level period.

The first and second pixels PX1 and PX2 receive the data voltages corresponding to the 2D image data in response to the gate signals sequentially provided in the unit of row. Accordingly, the first and second pixels PX1 and PX2 display the 2D image each frame FRM using the data voltages corresponding to the 2D image data.

FIG. 4 is a timing diagram of gate signals output from a gate driver when a mode signal is a 3D mode signal according to an exemplary embodiment of the present inventive concept.

Referring to FIG. 4, each frame FRM includes two sub-frames SFRM1 and SFRM2 in the 3D mode. For example, one frame FRM includes a first sub-frame SFRM1 and a second sub-frame SFRM2. The left-eye image Li is displayed in the first sub-frame SFRM1 and the right-eye image is displayed in the second sub-frame SFRM2. Therefore, the 3D image is displayed in one frame FRM.

Referring back to FIG. 2, one of the dual-gate signals, which each include two sub-gate signals having the same phase, is applied to first and second pixels PX1 and PX2 in a first row and a third row (e.g., odd-numbered rows) through the gate lines GLi and GLi+2, respectively. In addition, another dual-gate signal is applied to first and second pixels PX1 and PX2 in a second row and a fourth row (e.g., even-numbered rows) through the gate lines GLi+1 and GLi+3, respectively. The first and second pixels PX1 and PX2 arranged in the first row and the first and second pixels PX1 and PX2 arranged in the third row have the same arrangement as each other in the row direction.

For example, the dual-gate signals are sequentially applied to the first and second pixels PX1 and PX2 in the unit of two rows of the odd-numbered rows and the even-numbered rows.

Referring to FIG. 2, the first and second pixels PX1 and PX2 arranged in the odd-numbered rows have the same arrangement as each other, and the first and second pixels PX1 and PX2 arranged in the even-numbered rows have the same arrangement as each other.

Referring back to FIG. 4, a first double-gate signal DGS 1 among the double-gate signals DGS is applied to first and second pixels PX1 and PX2 which are connected to the first and third gate lines GL1 and GL3, respectively. As described above, each of the first pixels PX1 may include the sub-pixels Rx and Gx, and each of the second pixels PX2 may include the sub-pixels Bx and Wx. In addition, a second double-gate signal DGS2 among the double-gate signals DGS is applied to first and second pixels PX1 and PX2 which are connected to the second and fourth gate lines GL2 and GL4, respectively.

For example, the first double-gate signal DGS1 and the second double-gate signal DGS2 may be sequentially applied to the sub-pixels Rx, Gx, Bx, and Wx arranged in the first and third rows, and the sub-pixels Rx, Gx, Bx, and Wx arranged in the second and fourth rows.

The applying of the double-gate signals DGS is repeated until a double-gate signal DGS is applied to the sub-pixels Rx, Gx, Bx, and Wx connected to the last gate line GLn. Therefore, the double-gate signals DGS are sequentially applied to the sub-pixels Rx, Gx, Bx, and Wx in the unit of two rows of the odd-numbered rows, and the double-gate signals DGS are sequentially applied to the sub-pixels Rx, Gx, Bx, and Wx in the unit of two rows of the even-numbered rows.

The first and second pixels PX1 and PX2 receive the data voltages corresponding to the 3D image data in response to the double-gate signal DGS. Thus, the first and second pixels PX1 and PX2 display the 3D image using the data voltages corresponding to the 3D image data each frame FRM.

When the 2D image data is displayed in the display panel 110, the gate signals are sequentially applied to the first and second pixels PX1 and PX2 through the gate lines GL1 to GLn during the one frame FRM, and thus one image is displayed in the display panel 110.

When the 3D image data is displayed in the display panel 110, the left-eye image and the right-eye image are displayed in one frame FRM. The dual-gate signals are sequentially applied to the first and second pixels PX1 and PX2 in the first sub-frame SFRM1 and in the second sub-frame SFRM2. Accordingly, a frequency of the gate signals in the 3D mode may become two times faster than that in the 2D mode since the gate signals are applied two times in one frame FRM in the 3D mode, and the gate signals are applied one time in one frame FRM. Thus, an activation period 1H of each gate signal in the 3D mode may be shorter than that in the 2D mode.

The first and second pixels PX1 and PX2 are charged with the data voltages during the activation period 1H of each gate signal. As the activation period becomes shorter, a time for charging the first and second pixels PX1 and PX2 with the data voltages becomes shorter. For example, since the activation period 1H of each gate signal when the 3D image is displayed is shorter than that when the 2D image is displayed, the charge time of the first and second pixels PX1 and PX2 with the data voltages may be shortened. In this case, the first and second pixels PX1 and PX2 may not be charged with normal data voltages (e.g., desired data voltages).

To prevent the first and second pixels PX1 and PX2 from being charged with abnormal data voltages, the double-gate signal DGSs according to an exemplary embodiment of the present inventive concept may be employed. For example, the double-gate signals DGS including the sub-gate signals having the same phase are sequentially applied to the first and second pixels PX1 and PX2 in the unit of two gate lines.

In this case, the activation period 1H of each gate signal in the first sub-frame SFRM1 may be substantially the same as the activation period 1H of each gate signal when the 2D image data is displayed. In addition, the activation period 1H of each gate signal in the second sub-frame SFRM2 may be substantially the same as the activation period 1H of each gate signal when the 2D image data is displayed.

For example, since the double-gate signals DGS are applied to the first and second pixels PX1 and PX2 in each sub-frame SFRM1 and SFRM2, the charge time of the first and second pixels PX1 and PX2 with data voltages may be sufficiently secured even though the sequential gate signal are used to display the 3D image.

In general, the double-gate signals DGS may be applied to the sub-pixels Rx, Gx, Bx, and Wx in the unit of two rows which include one odd-numbered row and one even-numbered row, which are adjacent to each other. The sub-pixels Rx, Gx, Bx, and Wx arranged in the odd-numbered rows may be arranged in the different arrangement order from that of the sub-pixels Rx, Gx, Bx, and Wx arranged in the even-numbered rows. In this case, the sub-pixels Rx, Gx, Bx, and Wx arranged in the different arrangement orders in the row direction may be applied with the same data voltages in response to the common double-gate signal DGS.

When the same data voltages are applied to the sub-pixels Rx, Gx, Bx, and Wx having the different arrangement orders, for example, at the same time, color information, e.g., color coordinates, may be abnormally displayed.

To prevent the color information from being abnormally displayed, the same data voltages are required to be applied to the sub-pixels having the same arrangement order. For example, when the double-gate signal DGS is applied to the sub-pixels having the same arrangement order in the row direction, the color information may be normally displayed. Therefore, display quality of the display apparatus 100 may be prevented from being deteriorated.

FIG. 5 is a block diagram of the data processing device 150 shown in FIG. 1 according to an exemplary embodiment of the present inventive concept.

Referring to FIG. 5, the data processing device 150 includes a gamma compensating part 151, a mapping part 152, a sub-pixel rendering part 153, and a reverse-gamma compensating part 154.

The gamma compensating part 151 receives the red, green, and blue image data R, G, and B. The input image data R, G, and B may have a non-linear characteristic. The gamma compensating part 151 applies a gamma function to the red, green, and blue image data R, G, and B having the non-linear characteristic to generate the red, green, and blue image data R, G, and B having a linear characteristic.

When data processing on the red, green, and blue image data R, G, and B having the non-linear characteristic is performed in the blocks following the gamma compensating part 151 (e.g., the mapping part and the sub-pixel rendering part following the gamma compensating part 151), errors in software engineering may be generated.

The gamma compensating part 151 controls the red, green, and blue image data R, G, and B having the non-linear characteristic to generate the red, green, and blue image data R, G, and B having the linear characteristic, and thus the data processing in the blocks following the gamma compensating part 151 may become easier and error free. Hereinafter, the red, green, and blue image data R, G, and B having the linear characteristic output from the gamma compensating part 151 is referred to as linearized image data R′, G′, and B′. The linearized image data R′, G′, and B′ are applied to the mapping part 152.

The mapping part 152 maps the linearized red, green, and blue image data R′, G′, and B′ to red, green, blue, and white image data R′, G′, B′, and W′. In addition, the mapping part 152 maps RGB gamuts according to the red, green, and blue image data R′, G′, and B′ to RGBW gamuts according to the red, green, blue, and white image data R′, G′, B′, and W′ using a gamut mapping algorism (GMA). However, the gamut mapping operation of the mapping part 152 may be omitted.

The red, green, blue, and white image data R′, G′, B′, and W′ are applied to the sub-pixel rendering part 153. The sub-pixel rendering part 153 performs a rendering operation on the red, green, blue, and white image data R′, G′, B′, and W′.

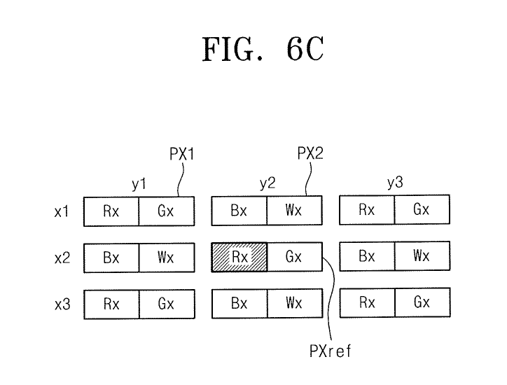

The sub-pixel rendering part 153 includes a rendering filter to perform the rendering operation. The sub-pixel rendering part 153 renders the red, green, blue, and white image data R′, G′, B′, and W′ using the rendering filter. The rendered red, green, blue, and white image data R″, G″, B″, and W″ are generated by the rendering filter. The rendering operation of the sub-pixel rendering part 153 will be described in detail with reference to FIGS. 6 to 8.

The rendered red, green, blue, and white image data R″, G″, B″, and W″ are applied to the reverse-gamma compensating part 154. The reverse-gamma compensating part 154 performs a reverse-gamma compensation on the red, green, blue, and white image data R″, G″, B″, and W″ to convert the red, green, blue, and white image data R″, G″, B″, and W″ to image data R, G, B, W before the gamma compensation is performed.

A data format of the red, green, blue, and white image data R, G, B, and W, which correspond to the output image of the reverse-gamma compensation, is converted by the timing controller 120, and the red, green, blue, and white image data R, G, B, and W having the converted data format are applied to the data driver 140.

FIGS. 6A, 6B, and 6C are views showing a rendering operation in a 2D mode according to an exemplary embodiment of the present inventive concept.

FIG. 6A is a plan view showing a three-pixel structure in which three sub-pixels are disposed in each pixel, FIG. 6B is a plan view showing a four-pixel structure in which four sub-pixels are disposed in each pixel, and FIG. 6C is a plan view showing a pentile pixel structure in which pixels having different sub-pixels from each other are disposed alternatively in row and column directions.

FIGS. 6A, 6B, and 6C show the pixels PX, PX1, and PX2 arranged in first to third rows x1 to x3 and first to third columns y1 to y3. For the convenience of explanation, the rows x1 to x3 and the columns y1 to y3 are represented by x-y coordinates. Each x-y coordinate of the three-pixel structure corresponds to each x-y coordinate of the four-pixel structure, and each x-y coordinate of four-pixel structure corresponds to each x-y coordinate of the pentile pixel structure.

Referring to FIGS. 6A, 6B, and 6C, each pixel PX in the three-pixel structure shown in FIG. 6A includes the red, green, and blue sub-pixels Rx, Gx, and Bx. Each pixel PX in the four-pixel structure shown in FIG. 6B includes the red, green, blue, and white sub-pixels Rx, Gx, Bx, and Wx.

A resolution of a display apparatus using the pentile pixel structure shown in FIG. 6C may be reduced by about half of a resolution of a display apparatus using the four-pixel structure shown in FIG. 6B. For example, each pixel PX1 or PX2 of the pentile pixel structure includes the red and green sub-pixels Rx and Gx or the blue and white sub-pixels Bx and Wx.

The input red, green, and blue image data R, G, and B are image data corresponding to the three-pixel structure. For example, each pixel PX of the three-pixel structure shown in FIG. 6A receives the red, green, and blue image data R, G, and B corresponding to e.g., the red, green, and blue sub-pixels Rx, Gx, and Bx, respectively.

The mapping part 152 maps the red, green, and blue image data R, G, and B to the red, green, blue, and white image R′, G′, B′, and W′. The red, green, blue, and white image R′, G′, B′, and W′ generated by the mapping part 152 are image data corresponding to the four-pixel structure. For example, each pixel PX of the four-pixel structure shown in FIG. 6B receives the red, green, blue, and white image R′, G′, B′, and W′.

The first and second pixels PX1 and PX2 arranged in the first to third rows x1 to and the first to third columns y1 to y3 of FIG. 6C correspond to the pixels PX, respectively, arranged in the first to third rows x1 to x3 and the first to third columns y1 to y3 shown in FIG. 6B. Accordingly, the red, green, blue, and white image R′, G′, B′, and W′ corresponding to each pixel PX shown in FIG. 6B correspond to each of the first and second pixels PX1 and PX2. For example, the red, green, blue, and white sub-pixels Rx, Gx, Bx, and Wx of each pixel PX shown in FIG. 6B may correspond to sub-pixels, respectively, of each of the first and second pixels PX1 and PX2 shown in FIG. 6C (e.g., the red and green sub-pixels Rx and Gx of the first PX1 and the blue and white sub-pixels Bx and Wx of the second PX2).

The pentile pixel structure of FIG. 6C is different from the four-pixel structure of FIG. 6B. Therefore, the red, green, blue, and white image R′, G′, B′, and W′ may not be applied to each pixel PX1 or PX2 of the pentile pixel structure. For example, the red, green, blue, and white image R′, G′, B′, and W′ corresponding to the pixel PX arranged in the second row x2 and the second column y2 in FIG. 6B may not be applied to the first pixel PX1 including the red and green sub-pixels Rx and Gx, which is arranged in the second row x2 and the second column y2 in FIG. 6C.

Thus, the sub-pixel rendering part 153 renders the red, green, blue, and white image R′, G′, B′, and W′ to the image data which is appropriate to be applied to the pentile pixel structure.

In addition, a resolution of the pentile pixel structure shown in FIG. 6C may be reduced by about half of a resolution of the four-pixel structure and an aperture ratio and transmittance of a display apparatus using the pentile pixel structure may be increased. In addition, to prevent display quality of the display apparatus from being deteriorated due to the reduction in the resolution, the sub-pixel rendering part 153 renders the red, green, blue, and white image R′, G′, B′, and W′.

For the rendering operation, the first rendering filter RF1 shown in FIG. 6B is used in the 2D mode. For example, the sub-pixel rendering part 153 includes the first rendering filter RF1. The first rendering filter RF1 shown in FIG. 6B may be referred to as a diamond filter RF1.

In the 2D mode, the sub-pixel rendering part 153 passes the red, green, blue, and white image R′, G′, B′, and W′ through the first rendering filter RF1 and renders the red, green, blue, and white image R′, G′, B′, and W′ to the image data corresponding to the sub-pixels Rx, Gx, Bx, and Wx.

Due to the rendering operation of the first rendering filter RF1, image data to be applied to a reference pixel PXref are determined using image data corresponding to the reference pixel PXref and image data corresponding to the first and second pixels PX1 and PX2 adjacent to the reference pixel PXref.

For example, the first rendering filter RF1 includes nine first sub-filters SF1 arranged in the first to third rows x1 to x3 and the first to third columns y1 to y3. For the convenience of explanation, the rows and the columns in which the first sub-filters SF1 are arranged are represented by x-y coordinates. In addition, each of the x-y coordinates of the first sub-filters SF1 corresponds to each of the x-y coordinates of the pixels PX shown in FIG. 6B, or each of the x-y coordinates of the first and second pixels PX1 and PX2 shown in FIG. 6C.

The first sub-filters SF1 store scale coefficients, respectively. A sum of the scale coefficients of the first sub-filters SF1 of the first rendering filter RF 1 may be set to about 1. The scale coefficient of the first sub-filter SF1 arranged in the second row x2 and the second column y2 may be set to about 0.5.

The scale coefficients of the first sub-filters SF1 respectively arranged in the first row x1 and the second column y2, the second row x2 and the first column y1, the second row x2 and the third column y3, and the third row x3 and the second column y2 may be set to about 0.125. The scale coefficients of the first sub-filters SF1 respectively arranged in the first row x1 and the first column y1, the first row x1 and the third column y3, the third row x3 and the first column y1, and the third row x3 and the third column y3 may be set to about zero (0).

For the rendering operation, first and second pixels PX1 and PX2 which correspond to the first sub-filters SF1 of the first rendering filter RF 1 and include the reference pixel PXref are set, and hereinafter, referred to as “set first and second pixels PX1 and PX2”. The reference pixel PXref in the pentile pixel structure corresponds to a pixel to which the rendered image data are applied.

Among the red, green, blue, and white image data R′, G′, B′, and W′ corresponding to the set first and second pixels PX1 and PX2, image data corresponding to colors of the sub-pixels of the reference pixel PXref are rendered through the first rendering filter RF 1. For example, the red and green image data R′ and G′ may correspond to the set first pixel PX1, and the blue and white image data B′ and W′ may correspond to the set second pixel PX2

For example, among the red, green, blue, and white image data R′, G′, B′, and W′ corresponding to the set first and second pixels PX1 and PX2, image data corresponding to a color of each sub-pixel of the reference pixel PXref are multiplied by the scale coefficients of the corresponding first sub-filters SF1. A sum of the multiplied values may be calculated as a rendering value of the image data corresponding to each sub-pixel of the reference pixel PXref.

Hereinafter, a rendering operation on the red image data R′ corresponding to the red sub-pixel Rx of the reference pixel PXref when the first pixel PX1 is set as the reference pixel PXref will be described in detail as an exemplary embodiment of the present inventive concept. In addition, since the image data R′, G′, B′, and W′ applied to the four-pixel structure are rendered through the first rendering filter RF 1, for the convenience of explanation, the first rendering filter RF1 is shown in FIG. 6B together with the four-pixel structure.

The first and second pixels PX1 and PX2 arranged in the first to third rows x1 to x3 and the first to third columns y1 to y3 shown in FIG. 6C are set as the pixels corresponding to the first sub-filters SF1 arranged in the first to third rows x1 to x3 and the first to third columns y1 to y3 shown in FIG. 6B.

Referring to FIG. 6C, among the first and second pixels PX1 and PX2 arranged in the first to third rows x1 to x3 and the first to third columns y1 to y3, the first pixel PX arranged in the second row x2 and the second column y2 is set to the reference pixel PXref. As described above, the rendered image data are applied to the reference pixel PXref. For example, the gate signals may be sequentially applied to the first and second pixels PX1 and PX2 in the unit of row, and the first pixel PX1 operated by each gate signal may be set to the reference pixel PXref.

Among the red, green, blue, and white image data R′, G′, B′, and W′ corresponding to the set first and second pixels PX1 and PX2, the red image data RI corresponding to the red color of the red sub-pixel Rx of the reference pixel PXref are rendered through the first rendering filter RF1.

For example, among the red, green, blue, and white image data R′, G′, B′, and W′ corresponding to each pixel PX shown in FIG. 6B, the red image data R′ of each pixel PX corresponding to the red color of the red sub-pixel Rx of the reference pixel PXref is multiplied by the scale coefficient of the corresponding first sub-filter RF1.

For example, nine red image data R′ of the nine pixels PX shown in FIG. 6B may be multiplied by the scale coefficients of the nine first sub-filters SF1 corresponding to the nine pixels PX, respectively. A sum of the nine multiplied values is calculated as a value of the rendered red image data R″ which corresponds to the red sub-pixel Rx of the reference pixel PXref.

Although not shown in figures, substantially the same rendering operation as the above-mentioned rendering operation on the red image data R′ may be performed on the green image data G′, and thus rendered green image data G″ may be generated. The green image data G′ may correspond to the green sub-pixel Gx of the reference pixel PXref. In addition, when the second pixel PX2 including the blue and white sub-pixels Bx and Wx are set to the reference pixel, substantially the same rendering operation as the above-mentioned rendering operations may be performed on the blue and white image data B′ and W′ respectively corresponding to the blue and white sub-pixels Bx and Wx, and thus rendered blue and white image data B″ and W″ may be generated.

The diamond filter RF1 has been shown in FIG. 6B as an exemplary embodiment of the present inventive concept, but the rendering filter is not limited to the diamond filter RF1.

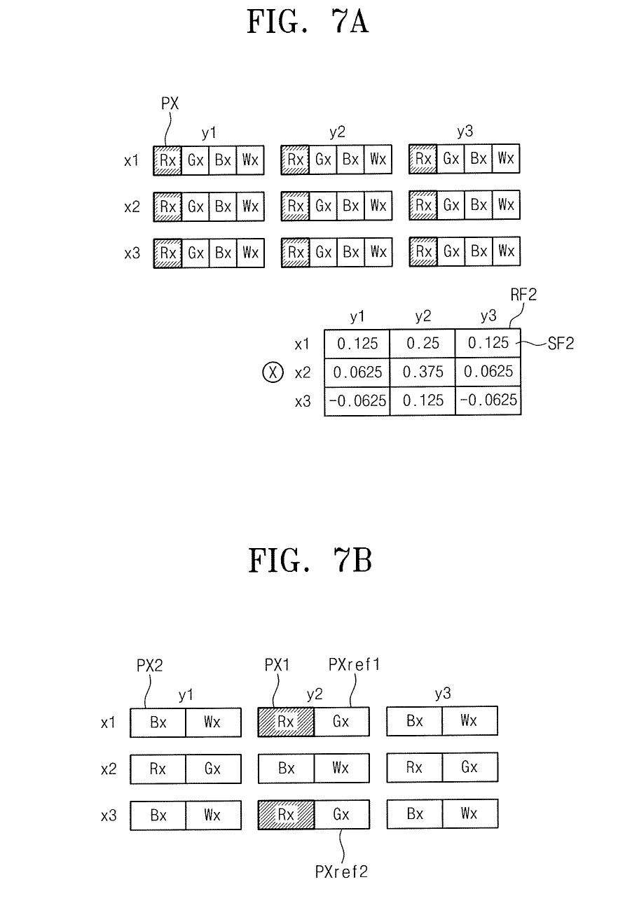

FIGS. 7A and 7B are views showing a rendering operation of image data corresponding to pixels arranged in odd-numbered rows in the 3D mode according to an exemplary embodiment of the present inventive concept.

FIG. 7A is a plan view showing a four-pixel structure including pixels PX arranged in the first to third rows x1 to x3 and the first to third columns y1 to y3 and a second rendering filter RF2, and FIG. 7B is a plan view showing a pentile pixel structure including first and second pixels PX1 and PX2 arranged in the first to third rows x1 to x3 and the first to third columns y1 to y3.

For the convenience of explanation, the rows x1 to x3 and the columns y1 to y3 are represented by x-y coordinates. In addition, each of the x-y coordinates of the four-pixel structure corresponds to each of the x-y coordinates of the pentile pixel structure.

As described with reference to FIGS. 6A, 6B, and 6C, the red, green, blue, and white image data R′, G′, B′, and W′ generated by the mapping part 152 are rendered by the sub-pixel rendering part 153 during the 3D mode.

In the 3D mode, the double-gate signals DGS are sequentially applied to the first and second pixels PX1 and PX2 in the unit of two rows of the odd-numbered rows and in the unit of two rows of the even-numbered rows. The second rendering filter RF2 performs the rendering operation on image data corresponding to first and second pixels PX1 and PX2 arranged in the odd-numbered rows.

Hereinafter, the rendering operation on the image data corresponding to the first and second pixels PX1 and PX2 arranged in the odd-numbered rows during the 3D mode will be described in detail with reference to FIGS. 7A and 7B.

The first and second pixels PX1 and PX2 arranged in the first to third rows x1 to x3 and the first to third columns y1 to y3 of FIG. 7A correspond to the pixels PX arranged in the first to third rows x1 to x3 and the first to third columns y1 to y3 of FIG. 7B. Accordingly, the red, green, blue, and white image data R′, G′, B′, and W′ corresponding to each pixel PX of FIG. 7A correspond to each of the first and second pixels PX1 and PX2 of FIG. 7B. For example, the red and green image data R′ and G′ may correspond to the first pixel PX1 of FIG. 7B, and the blue and white image data B′ and W′ may correspond to the second pixel PX2 of FIG. 7B.

The sub-pixel rendering part 153 includes the second rendering filter RF2. The sub-pixel rendering part 153 passes the red, green, blue, and white image data R′, G′, B′, and W′ through the second rendering filter RF2 in the 3D mode and renders the red, green, blue, and white image data R′, G′, B′, and W′ to the image data corresponding to the sub-pixels Rx, Gx, Bx, and Wx of the first and second pixels PX1 and PX2 arranged in the odd-numbered rows.

For example, the second rendering filter RF2 includes nine second sub-filters SF2 arranged in the first to third rows x1 to x3 and the first to third columns y1 to y3. For the convenience of explanation, the rows x1 to x3 and the columns y1 to y3 in which the second sub-filters SF2 are arranged are represented by the x-y coordinates. In addition, each of the x-y coordinates of the second sub-filters SF2 corresponds to each of the x-y coordinates of the pixels PX of FIG. 7A, or each of the x-y coordinates of the first and second pixels PX1 and PX2 of FIG. 7B.

In addition, the image data R′, G′, B′, and W′ corresponding to the four-pixel structure are rendered through the second rendering filter RF2, and thus, for the convenience of explanation, the second rendering filter RF2 is shown in FIG. 7A together with the four-pixel structure.

The second sub-filters SF2 store scale coefficients, respectively. A sum of the scale coefficients of the second sub-filters SF2 of the second rendering filter RF2 may be set to about 1. The scale coefficient of the second sub-filter SF2 arranged in the first row x1 and the second column y2 may be set to about 0.25. The scale coefficient of the second sub-filter SF2 arranged in the second row x2 and the second column y2 may be set to about 0.375.

The scale coefficients of the second sub-filters SF2 respectively arranged in the first row x1 and the first column y1, the first row x1 and the third column y3, and the third row x3 and the second column y2 may be set to about 0.125. The scale coefficients of the second sub-filters SF2 respectively arranged in the second row x2 and the first column y1 and the second row x2 and the third column y3 may be set to about 0.0625. The scale coefficients of the second sub-filters SF2 respectively arranged in the third row x3 and the first column y1 and the third row x3 and the third column y3 may be set to about −0.0625.

For the rendering operation, first and second pixels PX1 and PX2 that correspond to the second sub-filters SF2 of the second rendering filter RF2 and include first and second reference pixels PXref1 and PXref2 are set, and hereinafter, are referred to as “set first and second pixels PX1 and PX2”. In the pentile pixel structure, the rendered image data are applied to the first and second reference pixels PXref1 and PXref2 included in the set first and second pixels PX1 and PX2. In addition, the first and second reference pixels PXref1 and PXref2 include the same sub-pixels having the same arrangement as each other.

Among the red, green, blue, and white image data R′, G′, B′, and W′ corresponding to the set first and second pixels PX1 and PX2, image data corresponding to colors of the sub-pixels of the first and second reference pixels PXref1 and PXref2 are rendered through the second rendering filter RF2. For example, the red and green image data R′ and G′ may correspond to set the first pixel PX1, and the blue and white image data B′ and W′ may correspond to the set second pixel PX2.

For example, among the red, green, blue, and white image data R′, G′, B′, and W′ corresponding to the set first and second pixels PX1 and PX2, image data corresponding to a color of each sub-pixel of the first and second reference pixels PXref1 and PXref2 are multiplied by the scale coefficients of the corresponding second sub-filters SF2. A sum of the multiplied values may be calculated as a rendering value of the image data corresponding to each sub-pixel of the first and second reference pixels PXref1 and PXref2.

Hereinafter, a rendering operation on the red image data R′ corresponding to the red sub-pixels Rx of the first and second reference pixels PXref1 and PXref2 will be described when the first pixels PX1 are set as the first and second reference pixels PXref1 and PXref2 in an exemplary embodiment of the present inventive concept.

The first and second pixels PX1 and PX2 arranged in the first to third rows x1 to x3 and the first to third columns y1 to y3 shown in FIG. 7B are set as the pixels corresponding to the second sub-filters SF2 arranged in the first to third rows x1 to x3 and the first to third columns y1 to y3 shown in FIG. 7A.

Referring to FIG. 7B, the first and second pixels PX1 and PX2 arranged in the first and third rows x1 and x3 may be connected to the odd-numbered gate lines to receive the double-gate signal DGS. For example, the first and third rows x1 and x3 correspond to two rows of the odd-numbered rows, respectively, to which the double-gate signal DGS is applied.

In this case, among the first and second pixels PX1 and PX2 arranged in the first to third rows x1 to x3 and the first to third columns y1 to y3, the first pixel PX1 arranged in the first row x1 and the second column y2 is set as the first reference pixel PXref1, and the first pixel PX1 arranged in the third row x3 and the second column y2 is set as the second reference pixel PXref2.

As described above, the image data rendered by the second rendering filter RF2 are applied to the first and second reference pixels PXref1 and PXref2. For example, the double-gate signal DGSs are applied to the first and second pixels PX1 and PX2 in the unit of two rows of the odd-numbered rows during the 3D mode. Therefore, two first pixels PX1 arranged in the different odd-numbered rows and the same column may be driven by the double-gate signal DGS and may be set as the first and second reference pixels PXref1 and PXref2, respectively.

In addition, among the red, green, blue, and white image data R′, G′, B′, and W′ corresponding to the set first and second pixels PX1 and PX2, the red image data R′ corresponding to the red color of the red sub-pixels Rx of the first and second reference pixels PXref1 and PXref2 are rendered through the second rendering filter RF2.

For example, among the red, green, blue, and white image data R′, G′, B′, and W corresponding to each pixel PX shown in FIG. 7A, the red image data R′ of each pixel PX corresponding to the red color of the red sub-pixels Rx of the first and second reference pixels PXref1 and PXref2 is multiplied by the scale coefficient of the corresponding second sub-filter SF2.

For example, nine red image data R′ of the nine pixels PX shown in FIG. 7A may be multiplied by the scale coefficients of the nine second sub-filters SF2 that correspond to the nine pixels PX, respectively. A sum of the nine multiplied values is calculated as a value of the rendered red image data R′ corresponding to the red sub-pixels Rx of the first and second reference pixels PXref1 and PXref2. The rendered red image data R″ are respectively applied to the red sub-pixels Rx of the two first and second reference pixels PXref1 and PXref2 connected to the odd-numbered gate lines.

Although not shown in figures, substantially the same rendering operation as the above-mentioned rendering operation on the red image data R′ may be performed on the green image data G′, and thus rendered green image data G″ may be generated. The green image data G′ may correspond to the green sub-pixels Gx of the first and second reference pixels PXref1 and PXref2. In addition, when the second pixels PX2 each including the blue and white sub-pixels Bx and Wx are set as the first and second reference pixels PXref1 and PXref2, substantially the same rendering operation as the above-mentioned rendering operations may be performed on the blue and white image data B′ and W′, and thus rendered blue and white image data B″ and W″ may be generated.

Due to the above-mentioned operation, the image data corresponding to the first and second pixels PX1 and PX2 arranged in the odd-numbered rows may be rendered by the second rendering filter RF2 during the 3D mode.

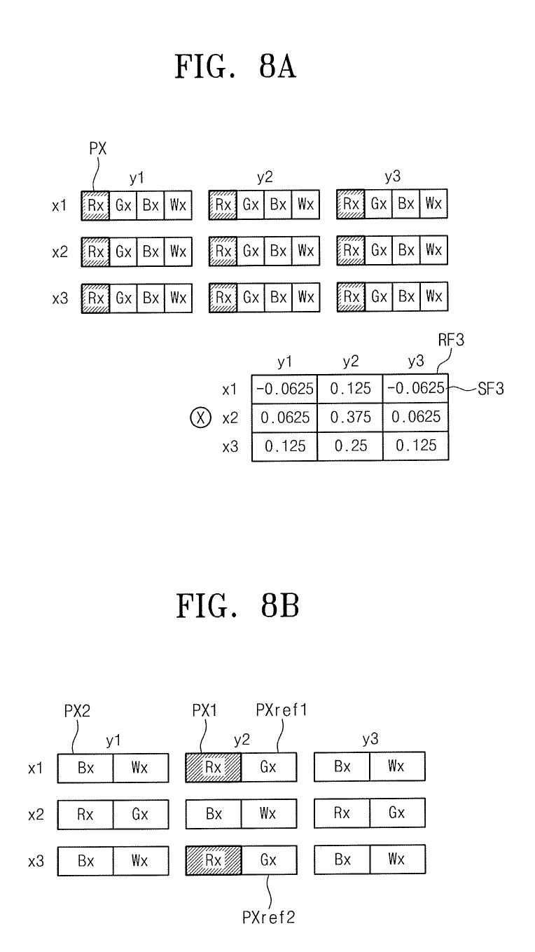

FIGS. 8A and 8B are views showing a rendering operation of image data corresponding to pixels arranged in even-numbered rows in the 3D mode according to an exemplary embodiment of the present inventive concept.

FIG. 8A is a plan view showing a four-pixel structure including pixels PX arranged in the first to third rows x1 to x3 and the first to third columns y1 to y3 and a third rendering filter RF3, and FIG. 8B is a plan view showing a pentile pixel structure including first and second pixels PX1 and PX2 arranged in the first to third rows x1 to x3 and the first to third columns y1 to y3. The arrangement of the pixels PX, PX1, and PX2 shown in FIGS. 8A and 8B is substantially the same as that of the pixels PX, PX1, and PX2 shown in FIGS. 7A and 7B.

The third rendering filter RF3 performs the rendering operation on image data corresponding to first and second pixels PX1 and PX2 arranged in the even-numbered rows.

Hereinafter, the rendering operation on the image data corresponding to the first and second pixels PX1 and PX2 arranged in the even-numbered rows during the 3D mode will be described in detail with reference to FIGS. 8A and 8B.

The red, green, blue, and white image data R′, G′, B′, and W′ corresponding to each pixel PX of FIG. 8A correspond to each of the first and second pixels PX1 and PX2 of FIG. 8B. For example, the red and green image data R′ and G′ may correspond to the first pixel PX1 of FIG. 8B, and the blue and white image data B′ and W′ may correspond to the second pixel PX2 of FIG. 8B

The sub-pixel rendering part 153 includes the third rendering filter RF3. The sub-pixel rendering part 153 passes the red, green, blue, and white image data R′, G′, B′, and W′ through the third rendering filter RF3 in the 3D mode and renders the red, green, blue, and white image data R′, G′, B′, and W′ to the image data corresponding to the sub-pixels Rx, Gx, Bx, and Wx of the first and second pixels PX1 and PX2 arranged in the even-numbered rows.

For example, the third rendering filter RF3 includes nine third sub-filters SF3 arranged in the first to third rows x1 to x3 and the first to third columns y1 to y3. The x-y coordinates of the third sub-filters SF3 correspond to the x-y coordinates of the pixels PX of FIG. 8A, or the x-y coordinates of the first and second pixels PX1 and PX2 of FIG. 8B. The third rendering filter RF3 is shown in FIG. 8A together with the four-pixel structure.

The third sub-filters SF3 store scale coefficients, respectively. A sum of the scale coefficients of the third sub-filters SF3 of the third rendering filter RF3 may be set to about 1. The scale coefficient of the third sub-filter SF3 arranged in the third row x3 and the second column y2 may be set to about 0.25. The scale coefficient of the third sub-filter SF3 arranged in the second row x2 and the second column y2 may be set to about 0.375.

The scale coefficients of the third sub-filters SF3 respectively arranged in the third row x3 and the first column y1, the third row x3 and the third column y3, and the first row x1 and the second column y2 may be set to about 0.125. The scale coefficients of the third sub-filters SF3 respectively arranged in the second row x2 and the first column y1 and the second row x2 and the third column y3 may be set to about 0.0625. The scale coefficients of the third sub-filters SF3 respectively arranged in the first row x1 and the first column y1 and the first row x1 and the third column y3 may be set to about −0.0625.

For the rendering operation, first and second pixels PX1 and PX2 that correspond to the third sub-filters SF3 of the third rendering filter RF3 and include first and second reference pixels PXref1 and PXref2 are set, and hereinafter, are referred to as “set first and second pixels PX1 and PX2”. In the pentile pixel structure, the rendered image data are applied to the first and second reference pixels PXref1 and PXref2 included in the set first and second pixels PX1 and PX2. In addition, the first and second reference pixels PXref1 and PXref2 include the same sub-pixels having the same arrangement as each other.

Among the red, green, blue, and white image data R′, G′, B′, and W′ corresponding to the set first and second pixels PX1 and PX2, image data corresponding to colors of the sub-pixels of the first and second reference pixels PXref1 and PXref2 are rendered through the third rendering filter RF3.

For example, among the red, green, blue, and white image data R′, G′, B′, and W′ corresponding to the set first and second pixels PX1 and PX2, image data corresponding to a color of each sub-pixel of the first and second reference pixels PXref1 and PXref2 are multiplied by the scale coefficients of the corresponding third sub-filters SF3. A sum of the multiplied values may be calculated as a rendering value of the image data corresponding to each sub-pixel of the first and second reference pixels PXref1 and PXref2.

Hereinafter, a rendering operation on the red image data R′ corresponding to the red sub-pixels Rx of the first and second reference pixels PXref1 and PXref2 will be described when the first pixels PX1 are set as the first and second reference pixels PXref1 and PXref2.

The first and second pixels PX1 and PX2 arranged in the first to third rows x1 to x3 and the first to third columns y1 to y3 shown in FIG. 8B are set as the pixels corresponding to the third sub-filters SF3 arranged in the first to third rows x1 to x3 and the first to third columns y1 to y3 shown in FIG. 8A.

Referring to FIG. 8B, the first and second pixels PX1 and PX2 arranged in the first and third rows x1 and x3 may be connected to the even-numbered gate lines to receive the double-gate signal DGS. For example, the first and third rows x1 and x3 correspond to two rows of the even-numbered rows, respectively, to which the double-gate signal DGS is applied.

In this case, among the first and second pixels PX1 and PX2 arranged in the first to third rows x1 to x3 and the first to third columns y1 to y3, the first pixel PX1 arranged in the first row x1 and the second column y2 is set as the first reference pixel PXref1, and the first pixel PX1 arranged in the third row x3 and the second column y2 is set as the second reference pixel PXref2.

As described above, the image data rendered by the third rendering filter RF3 are applied to the first and second reference pixels PXref1 and PXref2. For example, the double-gate signals DGS are applied to the first and second pixels PX1 and PX2 in the unit of two rows of the even-numbered rows during the 3D mode. Thus, two first pixels PX1 arranged in the different even-numbered rows and the same column may be driven by the double-gate signal DGS and may be set as the first and second reference pixels PXref1 and PXref2, respectively.

In addition, among the red, green, blue, and white image data R′, G′, B′, and W′ corresponding to the set first and second pixels PX1 and PX2, the red image data R′ corresponding to the red color of the red sub-pixels Rx of the first and second reference pixels PXref1 and PXref2 are rendered through the third rendering filter RF3.

For example, the nine red image data R′ of the pixels PX corresponding to the red color of the red sub-pixels of the first and second reference pixels PXref1 and PXref2 are respectively multiplied by the scale coefficients of the corresponding nine third sub-filters SF3. A sum of the multiplied values is calculated as a value of the rendered red image data R′ corresponding to the red sub-pixels Rx of the first and second reference pixels PXref1 and PXref2.

The rendered red image data R″ are respectively applied to the red sub-pixels Rx of the two first and second reference pixels PXref1 and PXref2 connected to the even-numbered gate lines.

Although not shown in figures, substantially the same rendering operation as the above-mentioned rendering operation on the red image data R′ may be performed on the green image data G′, and thus rendered green image data G″ may be generated. The green image data G′ may correspond to the green sub-pixels Gx of the first and second reference pixels PXref1 and PXref2. In addition, when the second pixels PX2 each including the blue and white sub-pixels Bx and Wx are set as the first and second reference pixels PXref1 and PXref2, substantially the same rendering operation as the above-mentioned rendering operations may be performed on the blue and white image data B′ and W′, and thus rendered blue and white image data B″ and W″ may be generated.

Due to the above-mentioned operation, the image data corresponding to the first and second pixels PX1 and PX2 arranged in the even-numbered rows may be rendered by the third rendering filter RF3 during the 3D mode.

Accordingly, when a display apparatus operates in the 3D mode, the image data corresponding to the first and second pixels PX1 and PX2 driven by the double-gate signal DGSs may be rendered to correspond to the 3D mode using the second and third rendering filters RF2 and RF3.

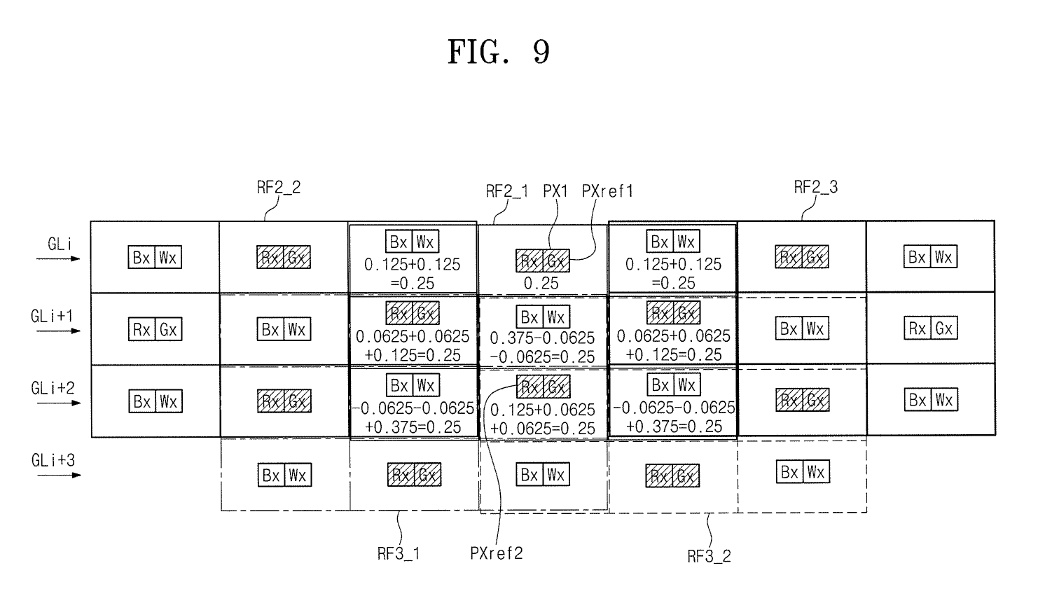

FIG. 9 is a view showing a method of setting scale coefficients of second sub-filters SF2 of a second rendering filter RF2 according to an exemplary embodiment of the present inventive concept.

For the convenience of explanation, the first pixels PX1 are set as the first and second reference pixels PXref1 and PXref2. In addition, the first and second pixels PX1 and PX2 corresponding to the second and third sub-filters SF2 and SF3, respectively are disposed to overlap with the second and third sub-filters SF2 and SF3.

In addition, the number of the first and second pixels PX1 and PX2 shown in FIG. 9 is not limited to the number shown in FIG. 9.

Referring to FIG. 9, when the double-gate signal DGS is applied to the first and second pixels PX1 and PX2 through two odd-numbered gate lines GLi and GLi+2, three second rendering filters RF2_1, RF2_2, and RF2_3 are disposed to partially overlap with each other.

When the double-gate signal DGS is applied to the first and second pixels PX1 and PX2 through two even-numbered gate lines GLi+1 and GLi+3, two third rendering filters RF3_1 and RF3_2 are disposed to partially overlap with each other. In addition, the third rendering filters RF3_1 and RF3_2 are disposed to partially overlap with the second rendering filters RF2_1, RF2_2, and RF2_3.

For the convenience of explanation, a boundary line of the second second-rendering filter RF2_2 is indicated by a line bolder than that of the first second-rendering filter RF2_1, and a boundary line of the third second-rendering filter RF2_3 is indicated by a line bolder than that of the second second-rendering filter RF2_2. In addition, the first third-rendering filter RF3_1 is indicated by an alternated long and short dash line, and the second third-rendering filter RF3_2 is indicated by a dotted line.

Although not shown in FIG. 9, for the convenience of explanation, the arranged positions of the second and third sub-filters SF2 and SF3 will be described using the x-y coordinates.

Second sub-filters SF2 arranged in the first column y1 of the first second-rendering filter RF2_1 overlap second sub-filters SF2 arranged in the third column y3 of the second second-rendering filter RF2_2. Second sub-filters SF2 arranged in the third column y3 of the first second-rendering filter RF2_1 overlap second sub-filters SF2 arranged in the first column y1 of the third second-rendering filter RF2_3.

Third sub-filters SF3 arranged in the third column y3 of the first third-rendering filter RF3_1 overlap third sub-filters SF3 arranged in the first column y1 of the second third-rendering filter RF3_2.

Second sub-filters SF2 arranged in the second and third rows x2 and x3 and the first and second columns y1 and y2 of the first second-rendering filter RF2_1 overlap third sub-filters SF3 arranged in the first and second rows x1 and x2 and the second and third columns y2 and y3 of the first third-rendering filter RF3_1.

Second sub-filters SF2 arranged in the second and third rows x2 and x3 and the second and third columns y2 and y3 of the first second-rendering filter RF2_1 overlap third sub-filters SF3 arranged in the first and second rows x1 and x2 and the first and second columns y1 and y2 of the second third-rendering filter RF3_2.

FIG. 9 shows scale coefficients of the second sub-filters SF2 of the first second-rendering filter RF2_1 and scale coefficients of the second sub-filters SF2 of the second rendering filters RF2_2 and RF2_3 overlapping the sub-filters SF2 of the first second-rendering filter RF2_1. In addition, FIG. 9 shows scale coefficients of the third sub-filters SF3 of the third rendering filters RF3_1 and RF3_2 overlapping the second sub-filters SF2 of the first second-rendering filter RF2_1.

Although all scale coefficients are not shown in FIG. 9, a sum of the scale coefficients of each of the second rendering filters RF2_1, RF2_2, and RF2_3 may be set to about 1 and a sum of the scale coefficients of each of the third rendering filters RF3_1 and RF3_2 may be set to about 2.

With respect to the first second-rendering filter RF2_1, a sum of the scale coefficient of each second sub-filter SF2 of the first second-rendering filter RF2_1 and the scale coefficients of the second sub-filters SF2 of the second rendering filters RF2_2 and RF2_3 and/or the third sub-filters SF3 of the third rendering filters RF3_1 and RF3_2 overlapping each second sub-filter SF2 of the first second-rendering filter RF2_1 may be set to about 0.25.

For example, with respect to the first second-rendering filter RF2_1, the second sub-filter SF2 arranged in the first row x1 and the second column y2 of the first second-rendering filter RF2_1 does not overlap the second and third sub-filters SF2 and SF3 of the second and third rendering filters RF2_2, RF2_3, RF3_1, and RF3_2. The scale coefficient of the second sub-filter SF2 arranged in the first row x1 and the second column y2 of the first second-rendering filter RF2_1 may be 0.25.

In addition, with respect to the first second-rendering filter RF2_1, the second sub-filter SF2 arranged in the first row x1 and the first column y1 of the first second-rendering filter RF2_1 overlaps the second sub-filter SF2 arranged in the first row x1 and the third column y3 of the second second-rendering filter RF2_2. The scale coefficient of the second sub-filter SF2 arranged in the first row x1 and the first column y1 of the first second-rendering filter RF2_1 is about 0.125 and the scale coefficient of the second sub-filter SF2 arranged in the first row x1 and the third column y3 of the second second-rendering filter RF2_2 is about 0.125.

Therefore, as shown in FIG. 9, a sum of the scale coefficients in the first row x1 and the first column y1 of the first second-rendering filter RF2_1 may be about 0.25 (e.g., 0.125+0.125).

In addition, with respect to the first second-rendering filter RF2_1, the second sub-filter SF2 arranged in the second row x2 and the first column y1 of the first second-rendering filter RF2_1 overlaps the second sub-filter SF2 arranged in the second row x2 and the third column y3 of the second second-rendering filter RF2_2 and the third sub-filter SF3 arranged in the first row x1 and the second column y2 of the first third-rendering filter RF3_1. The scale coefficient of the second sub-filter SF2 arranged in the second row x2 and the first column y1 of the first second-rendering filter RF2_1 is about 0.0625, the scale coefficient of the second sub-filter SF2 arranged in the second row x2 and the third column y3 of the second second-rendering filter RF2_2 is about 0.0625, and the scale coefficient of the third sub-filter SF3 arranged in the first row x1 and the second column y2 of the first third-rendering filter RF31 is about 0.125.

Thus, as shown in FIG. 9, a sum of the scale coefficients in the second row x2 and the first column y1 of the first second-rendering filter RF2_1 may be about 0.25 (e.g., 0.0625+0.0625+0.125).

In addition, with respect to the first second-rendering filter RF2_1, the second sub-filter SF2 arranged in the second row x2 and the second column y2 of the first second-rendering filter RF2_1 overlaps the third sub-filter SF3 arranged in the first row x1 and the third column y3 of the first third-rendering filter RF3_1 and the third sub-filter SF3 arranged in the first row x1 and the first column y1 of the second third-rendering filter RF3_2. The scale coefficient of the second sub-filter SF2 arranged in the second row x2 and the second column y2 of the first second-rendering filter RF2_1 is about 0.375, the scale coefficient of the third sub-filter SF3 arranged in the first row x1 and the third column y3 of the first third-rendering filter RF3_1 is about −0.0625, and the scale coefficient of the third sub-filter SF3 arranged in the first row x1 and the first column y1 of the second third-rendering filter RF3_2 is about −0.0625.

Accordingly, as shown in FIG. 9, a sum of the scale coefficients in the second row x2 and the second column y2 of the first second-rendering filter RF2_1 may be about 0.25 (e.g., 0.375-0.0625-0.0625).

The scale coefficients of the second sub-filters SF2 of the first second-rendering filter RF2_1 may be set as shown in FIG. 7A. In addition, the scale coefficients of the second and third second-rendering filters RF2_2 and RF2_3 may be set as shown in FIG. 7A. The scale coefficients of the third sub-filters SF3 of the third rendering filter RF3 may be set as shown in FIG. 8A. Therefore, the image data corresponding to the first and second pixels PX1 and PX2 driven by the double-gate signals DGS during the 3D mode may be rendered to correspond to the 3D mode using the second and third rendering filters RF2 and RF3.

Thus, the display apparatus 100 may render the image data to correspond to the 3D mode during the 3D mode in which the double-gate signals DGS are used.

Although the present inventive concept has been described with reference to exemplary embodiments thereof, it will be understood that the present inventive concept is not be limited to the disclosed exemplary embodiments and various changes and modifications in form and details may be made therein without departing from the spirit and scope of the present inventive concept.

What is claimed is:

1. A display apparatus comprising:
first pixels configured to receive data voltages in response to gate signals;
second pixels alternately arranged with the first pixels in a row direction and a column direction, the second pixels being configured to receive the data voltages in response to the gate signals;
a gate driver configured to provide the gate signals to the first and second pixels; and
a data driver configured to provide the data voltages to the first and second pixels,
wherein each of the first pixels comprises sub-pixels different from sub-pixels of each of the second pixels,
wherein the gate signals are sequentially applied to the first and second pixels in a unit of row in a two-dimensional (2D) mode,
wherein dual-gate signals each including two sub-gate signals having a same phase as each other are sequentially applied to the first and second pixels in a unit of two rows of odd-numbered rows and in a unit of two rows of even-numbered rows as the gate signals in a three-dimensional (3D) mode.

2. The display apparatus of claim 1, wherein the gate signals are applied to the first and second pixels each frame during the 2D mode, and
wherein the frame comprises a first sub-frame in which a left-eye image is displayed and a second sub-frame in which a right-eye image is displayed, and the double-gate signals are applied to the first and second pixels each sub-frame during the 3D mode.

3. The display apparatus of claim 1, wherein each of the first pixels comprises a red sub-pixel and a green sub-pixel, and each of the second pixels comprises a blue sub-pixel and a white sub-pixel.

4. The display apparatus of claim 1, further comprising a timing controller configured to render input image data to correspond to the sub-pixels, to convert a data format of the rendered image data, and to apply the image data having the converted data format to the data driver,
wherein the data driver outputs the data voltages corresponding to the image data having the converted data format.

5. The display apparatus of claim 4, wherein the input image data comprise red, green, and blue image data, and the timing controller comprises:
a gamma compensating part configured to linearize the red, green, and blue image data;
a mapping part configured to map the linearized red, green, and blue image data to red, green, blue, and white image data;
a sub-pixel rendering part configured to render the mapped red, green, blue, and white image data, and to output the rendered red, green, blue, and white image data corresponding to the sub-pixels; and
a reverse-gamma compensating part configured to perform reverse-gamma compensation on the rendered red, green, blue, and white image data.

6. The display apparatus of claim 5, wherein the sub-pixel rendering part comprises at least one of a first rendering filter, a second rendering filter, or a third rendering filter,
wherein the first rendering filter is used to render the mapped red, green, blue, and white image data to correspond to the sub-pixels during the 2D mode,
wherein the second rendering filter is used to render the mapped red, green, blue, and white image data to correspond to sub-pixels arranged in the odd-numbered rows, among the sub-pixels, during the 3D mode,
wherein the third rendering filter is used to render the mapped red, green, blue, and white image data to correspond to sub-pixels arranged in the even-numbered rows, among the sub-pixels, during the 3D mode.

7. The display apparatus of claim 6, wherein the first rendering filter comprises first sub-filters arranged in first to third rows and first to third columns,
wherein the first sub-filters have corresponding scale coefficients, respectively,
wherein the sub-pixel rendering part is configured to set first and second pixels, among the first and second pixels, arranged in the first to third rows and the first to third columns to correspond to the first sub-filters, to set a first or second pixel arranged in the second row and the second column among the set first and second pixels as a reference pixel, to multiply first image data corresponding to a color of a sub-pixel of the reference pixel, among the mapped red, green, blue, and white image data corresponding to the set first and second pixels, by corresponding scale coefficients of the first sub-filters corresponding to the first image data, respectively, and to calculate a sum of the multiplied values as a rendered image data corresponding to the sub-pixel of the reference pixel.

8. The display apparatus of claim 7, wherein a sum of the scale coefficients of the first sub-filters is about 1, a scale coefficient of the first sub-filter arranged in the second row and the second column is about 0.5, a scale coefficient of each of the first sub-filters respectively arranged in the first row and the second column, the second row and the first column, the second row and the third column, and the third row and the second column is about 0.125, and a scale coefficient of each of the first sub-filters respectively arranged in the first row and the first column, the first row and the third column, the third row and the first column, and the third row and the third column is 0.

9. The display apparatus of claim 6, wherein the second rendering filter comprises second sub-filters arranged in first to third rows and first to third columns,
wherein the second sub-filters have corresponding scale coefficients, respectively,
wherein the sub-pixel rendering part is configured to set first and second pixels, among the first and second pixels, arranged in the first to third rows and the first to third columns to correspond to the second sub-filters, to set one first or second pixel arranged in the first row and the second column among the set first and second pixels as a first reference pixel, to set another first or second pixel arranged in the third row and the second column among the set first and second pixels as a second reference pixel, to multiply first image data corresponding to a first color of sub-pixels of the first and second reference pixels, among the mapped red, green, blue, and white image data corresponding to the set first and second pixels, by corresponding scale coefficients of the second sub-filters corresponding to the first image data, respectively, and to calculate a sum of the multiplied values as rendered image data corresponding to the sub-pixels of the first and second reference pixels, and
wherein the first and third rows among the first to third rows correspond to the two rows of the odd-numbered rows to which one of the double-gate signals is applied.

10. The display apparatus of claim 6, wherein the third rendering filter comprises third sub-filters arranged in first to third rows and first to third columns
wherein the third sub-filters have corresponding scale coefficients, respectively,
wherein the sub-pixel rendering part is configured to set first and second pixels, among the first and second pixels, arranged in the first to third rows and the first to third columns to correspond to the third sub-filters, to set one first or second pixel arranged in the first row and the second column among the set first and second pixels as a first reference pixel, to set another first or second pixel arranged in the third row and the second column among the set first and second pixels as a second reference pixel, to multiply first image data corresponding to a first color of sub-pixels of the first and second reference pixels, among the mapped red, green, blue, and white image data corresponding to the set first and second pixels, by the corresponding scale coefficients of the third sub-filters corresponding to the first image data, respectively, and to calculate a sum of the multiplied values as rendered image data corresponding to the sub-pixels of the first and second reference pixels, and
wherein the first and third rows among the first to third rows correspond to the two rows of the even-numbered rows to which one of the double-gate signals is applied.

11. A method of driving a display apparatus, wherein the display apparatus comprises first pixels configured to receive data voltages in response to gate signals and second pixels alternately arranged with the first pixels in a row direction and a column direction, and the second pixels being configured to receive the data voltages in response to the gate signals and each of the second pixels including sub-pixels different from sub-pixels of each of the first pixels, comprising:
rendering input image data to image data corresponding to the sub-pixels;
applying the gate signals to the first and second pixels; and
applying the data voltages corresponding to the rendered image data to the first and second pixels,
wherein the gate signals are sequentially applied to the first and second pixels in a unit of row in a two-dimensional (2D) mode,
wherein dual-gate signals each including two sub-gate signals having a same phase as each other are sequentially applied to the first and second pixels in a unit of two rows of odd-numbered rows and in a unit of two rows of even-numbered rows as the gate signals in a three-dimensional mode (3D).

12. The method of claim 11, wherein the gate signals are applied to the first and second pixels each frame during the 2D mode, and
wherein the frame comprises a first sub-frame in which a left-eye image is displayed and a second sub-frame in which a right-eye image is displayed, and the double-gate signals are applied to the first and second pixels each sub-frame during the 3D mode.

13. The method of claim 11, wherein each of the first pixels comprises a red sub-pixel and a green sub-pixel, and each of the second pixels comprises a blue sub-pixel and a white sub-pixel.

14. The method of claim 13, wherein the input image data comprise red, green, and blue image data, and the rendering of the input image data comprises:
linearizing the red, green, and blue image data;
mapping the linearized red, green, and blue image data to red, green, blue, and white image data;
rendering the mapped red, green, blue, and white image data to correspond to the sub-pixels; and
performing a reverse-gamma compensation on the rendered red, green, blue, and white image data.

15. The method of claim 14, wherein the rendering of the mapped red, green, blue, and white image data in the 2D mode comprises:
setting first and second pixels arranged in first to third rows and first to third columns to correspond to first sub-filters arranged in the first to third rows and the first to third columns of a first rendering filter;
setting a first or second pixel arranged in the second row and the second column among the set first and second pixels as a reference pixel;
multiplying first image data corresponding to a color of a sub-pixel of the reference pixel, among the mapped red, green, blue, and white image data corresponding to the set first and second pixels, by scale coefficients of the first sub-filters corresponding to the first image data, respectively; and
calculating a sum of the multiplied values as a rendered image data corresponding to the sub-pixel of the reference pixel.

16. The method of claim 14, wherein the rendering of the mapped red, green, blue, and white image data in the 3D mode comprises:
setting first and second pixels arranged in the first to third rows and the first to third columns to correspond to second sub-filters arranged in the first to third rows and the first to third columns of a second rendering filter;
setting one first or second pixel arranged in the first row and the second column among the set first and second pixels as a first reference pixel;
setting another first or second pixel arranged in the third row and the second column among the set first and second pixels as a second reference pixel;
multiplying first image data corresponding to a first color of sub-pixels of the first and second reference pixels, among the mapped red, green, blue, and white image data corresponding to the set first and second pixels, by scale coefficients of the second sub-filters corresponding to the first image data, respectively; and
calculating a sum of the multiplied values as rendered image data corresponding to the sub-pixels of the first and second reference pixels,
wherein the first and third rows among the first to third rows correspond to the two rows of the odd-numbered rows to which one of the double-gate signals is applied.

17. The method of claim 14, wherein the rendering of the mapped red, green, blue, and white image data in the 3D mode comprises:
setting first and second pixels arranged in the first to third rows and the first to third columns to correspond to third sub-filters arranged in the first to third rows and the first to third columns of a third rendering filter;
setting one first or second pixel arranged in the first row and the second column among the set first and second pixels as a first reference pixel;
setting another first or second pixel arranged in the third row and the second column among the set first and second pixels as a second reference pixel;
multiplying first image data corresponding to a first color of sub-pixels of the first and second reference pixels, among the mapped red, green, blue, and white image data corresponding to the set first and second pixels, by scale coefficients of the third sub-filters corresponding to the first image data, respectively;
calculating a sum of the multiplied values as rendered image data corresponding to the sub-pixels of the first and second reference pixels,
wherein the first and third rows among the first to third rows correspond to the two rows of the even-numbered rows to which one of the double-gate signals is applied.

18. A display apparatus comprising:
first pixels configured to receive data voltages in response to gate signals;
second pixels alternately arranged with the first pixels in a row direction and a column direction, the second pixels being configured to receive the data voltages in response to the gate signals;
a gate driver configured to provide the gate signals to the first and second pixels;
a data driver configured to provide the data voltages to the first and second pixels; and
a timing controller configured to render input image data to image data corresponding to the sub-pixels,
wherein the time controller comprises:
a gamma compensating part configured to linearize input red, green, and blue image data;
a mapping part configured to map the linearized red, green, and blue image data to red, green, blue, and white image data; and
a sub-pixel rendering part configured to render the mapped red, green, blue, and white image data, and to output the rendered red, green, blue, and white image data corresponding to the sub-pixels, the sub-pixel rendering part including a first rendering filter and a second rendering filter having a different scale coefficient from that of the first rendering filter.

19. The display apparatus of claim 18, wherein the first rendering filter is used to render the mapped red, green, blue, and white image data to correspond to sub-pixels arranged in the odd-numbered rows, among the sub-pixels, during the 3D mode, and
wherein the second rendering filter is used to render the mapped red, green, blue, and white image data to correspond to sub-pixels arranged in the even-numbered rows, among the sub-pixels, during the 3D mode.

20. The display apparatus of claim 18, wherein each of the first pixels comprises a red sub-pixel and a green sub-pixel, and each of the second pixels comprises a blue sub-pixel and a white sub-pixel.
